(19) United States
(12) Patent Application Publication
(10) Pub. No.: US 2003/0108694 A1
(43) Pub. Date: Jun. 12, 2003

(54) Reinforced transparent glass assembly

(76) Inventor: Cheng-Tsung Lin, Taichung (TW)

Correspondence Address: CHENG-TSUNG LIN, P.O. BOX 2103, Taichung, TW

(21) Appl. No.: 10/011,402

(22) Filed: Dec. 11, 2001

(51) Int. Cl. E06B 3/24

(52) U.S. Cl. 428/34.1; 428/34

(57) ABSTRACT

A reinforced transparent glass assembly including a glass board, a corresponding PC board and a hollow frame body sandwiched between the glass board and the PC board. A drier is filled in the interior space of the hollow frame body. The frame body has an inner rim and an outer rim. Multiple apertures are formed through the inner rim of the frame body to communicate with the interior space thereof. The frame body has a dimension smaller than those of the glass board and the PC board, whereby a recess is defined by the outer rim and the glass board and the PC board. A soft and resilient gum material is filled in the recess for binding the frame body, glass board and PC board together. The drier filled in the interior space of the frame body via the apertures of the inner rim of the frame body is able to keep the internal space of the transparent glass assembly dry.

### BACKGROUND OF THE INVENTION

The present invention is related to a reinforced transparent glass assembly including a glass board, a PC board and a frame body sandwiched therebetween. The reinforced transparent glass assembly is anti-collision and the surface thereof is not subject to wearing.

An existent transparent glass is made of glass board or PC board. With respect to the glass board, the surface hardness is good (up to 7H) and the transparency is good. The surface of the glass board is not subject to wearing. However, the glass board has poor flexibility. When suffering an external impact, the glass board is subject to cracking. Therefore, when applied to those sites where greater impact may take place, the glass board is likely to crack and lead to danger. In order to overcome the above problem, generally the thickness of the safety glass is increased to a bulletproof glass is used to lower danger. However, such glass is expensive. With respect to PC board, it is able to bear greater impact (about 250 times greater than tempered glass). However, the surface hardness of the PC board is only 0.5H. Therefore, the surface of the PC board is subject to wearing and cutting.

In order to ensure safety and have beautiful appearance, a common jewel show cabinet is made of tempered glass. However, in case of robbery and strong impact, the tempered glass will be still broken. Moreover, in the show site, an illuminator is lastingly used. Therefore, the difference between external and internal temperatures is great. As a result, the show cabinet is subject to fogging due to humidity.

In addition, in a mill, when processing a work piece with a lathe or a CNC, a protective shield is added to the machine to prevent the metal chips from flying out. An observation window is formed in a certain position of the protective shield and a tempered glass is mounted in the observation window for an operator to check the operation. However, in case the work piece or the milling tool of the lathe flies out due to untrue clamping, the work piece or the milling tool still may break the tempered glass and fly out to cause accident. Furthermore, after a long period of milling, the machine will heat to fog the tempered glass and affect vision.

### SUMMARY OF THE INVENTION

It is therefore a primary object of the present invention to provide a reinforced transparent glass assembly including a glass board, a corresponding PC board and a hollow frame body sandwiched between the glass board and the PC board. With both the glass board and the PC board, the reinforced transparent glass assembly not only has good surface hardness, but also has a good flexibility so that the reinforced transparent glass assembly is anti-impact and anti-wear.

It is a further object of the present invention to provide the above reinforced transparent glass assembly in which a drier is filled in the interior space of the frame body and multiple apertures are formed through the inner rim of the frame body to communicate the interior space with the internal space defined between the glass board and the PC board. Therefore, the drier filled in the interior space is able to keep the air in the internal space dry and avoid fogging caused by difference between internal and external temperatures.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invention;

FIG. 3 is a sectional view of the present invention;

FIG. 4 is a sectional view showing that the present invention suffers an impact in one state; and

FIG. 5 is a sectional view showing that the present invention suffers an impact in another state.

Attachment 1 is a TUV Rheinland test report.

### DETAILED DESCRIPTION OF THE PREFERRED EMBODIMENTS

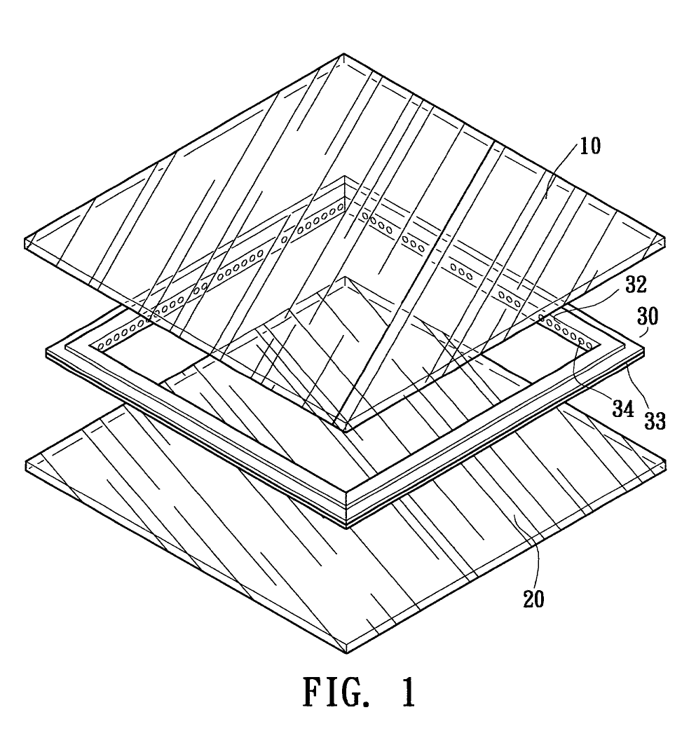

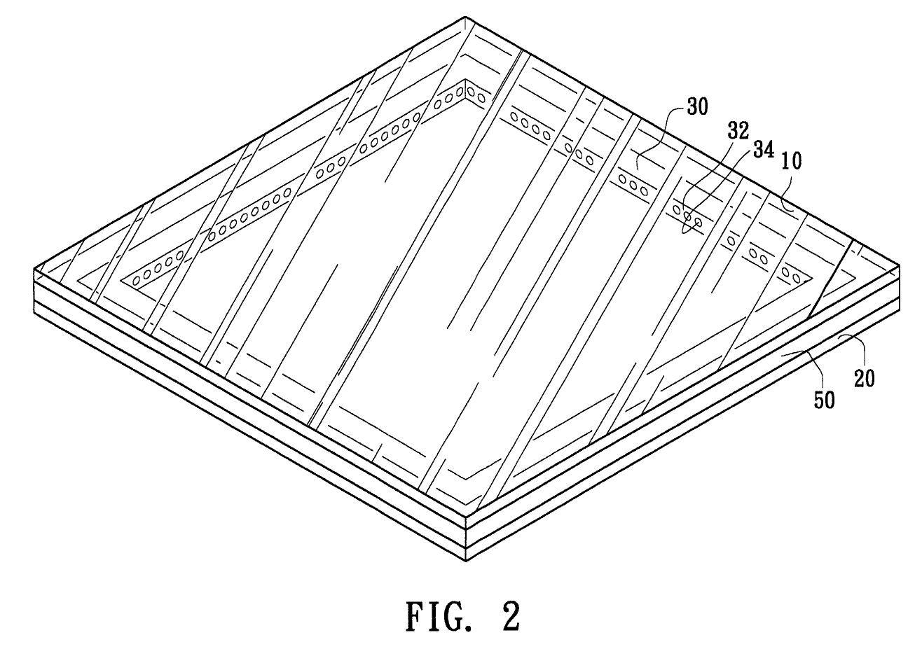

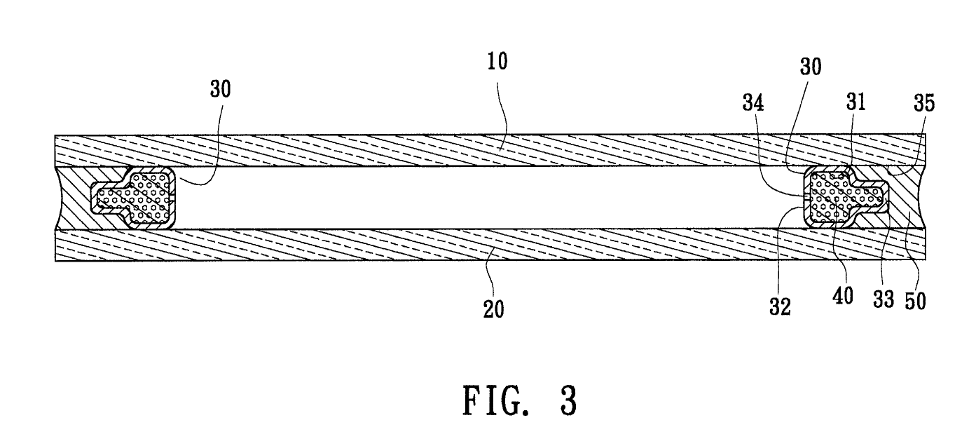

Please refer to FIGS. 1 to 4. The reinforced transparent glass assembly of the present invention includes a glass board 10, a corresponding PC board 20 and a frame body 30 sandwiched between the glass board 10 and the PC board 20. In this embodiment, the glass board 10 is made of tempered glass. The adjoining faces of the glass board 10, PC board 20 and frame body 30 are all plane faces. The glass board 10 and the PC board 20 are spaced from each other at a certain distance by the frame body 30. The frame body 30 is hollow and has an interior space 31 in which a drier 40 is filled. The frame body 30 has an inner rim 32 and an outer rim 33 opposite to the inner rim 32. The outer rim 33 has an outward extending projection. Multiple apertures 34 are formed through the inner rim 32 of the frame body 30 to communicate with the interior space 31. The frame body 30 has a dimension smaller than those of the glass board 10 and the PC board 20, whereby a recess 35 is defined by the outer rim 33 and the glass board 10 and the PC board 20. A soft and resilient gum material 50 such as thermoplastic glue or silicone is filled in the recess 35 for binding the frame body 30, glass board 10 and PC board 20 together.

The apertures 34 formed through the inner rim 32 of the frame body 30 communicate the interior space 31 of the frame body 30 and the space defined between the glass board 10 and the PC board 20. Therefore, the drier filled in the interior space 31 is able to keep the air in the space dry and avoid fogging of the glass board 10.

Moreover, the outer rim 33 of the frame body 30 has a projection for enlarging contact area between the outer rim 33 and the gum material 50 and thus enhancing binding effect.

The present invention has the following advantages:

1. One face of the reinforced transparent glass assembly of the present invention is the PC board, while the other face thereof is the tempered glass. The PC (polycarbonate) board has excellent anti-collision ability. It is proved by test that:

a. According to impact strength test (ASTMD 256A): board thickness 3 m/m V-shaped impact test 12-16 ft-lb/in, board thickness 3 m/m non-V-shaped impact test 60 ft-lb/in.

b. Ball falling impact strength: board thickness 6 m/m, φ 25 m/m weight 51 lb free fall from 40 ft tower 200 ft-lb/in.

c. The impact strength of such board material is 250 times greater than the strength of the tempered glass. The tempered glass has a good surface hardness (up to 7H) and good surface transparency. However, when suffering a greater impact force, the glass is subject to cracking. The PC board is advantageous in that it is able to bear greater impact force (250 times greater). However, the surface hardness of the PC board is only 0.5H. Therefore, the surface is subject to abrasion or cutting. The above two materials are combined to avoid wearing of the surface and bear greater impact force so as to ensure safety.

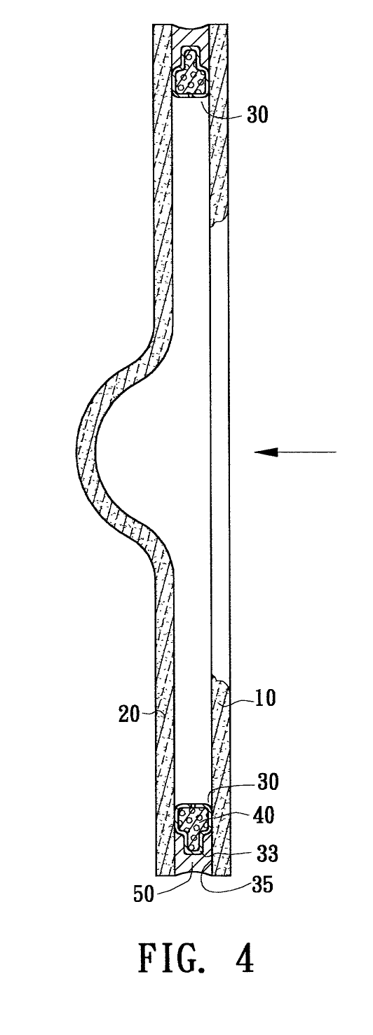

Referring to FIG. 4, the tempered glass with good hardness is arranged as the facial layer, while the PC board with good anti-collision ability is arranged as the inner layer. For example, in a CNC working site, in case a work piece clamped by a lathe or a milling tool of a miller incautiously flies out, the great impact of the work piece or milling tool may break the glass board of the present invention. However, the PC board is able to bear the impact and will be only depressed. Accordingly, the PC board serves as a protective layer against the flying work piece or milling tool. Therefore, the work piece or milling tool and the glass chips are prevented from flying out to hurt workers. (Please refer to Attachment 1.)

2. The frame body is sandwiched between the tempered glass board and the PC board to define a space. The apertures formed through the inner rim of the frame body communicate the interior space of the frame body and the space defined between the glass board and the PC board. Therefore, the drier filled in the interior space is able to keep the air in the space dry and avoid fogging of the glass board caused by difference between internal and external temperatures.

3. The frame body has a dimension slightly smaller than those of the glass board and the PC board, whereby a recess is defined by the outer rim and the glass board and the PC board. Soft and resilient thermoplastic glue or silicone is filled into the recess to serve as a cushion for absorbing shock and external impact and providing a buffing effect.

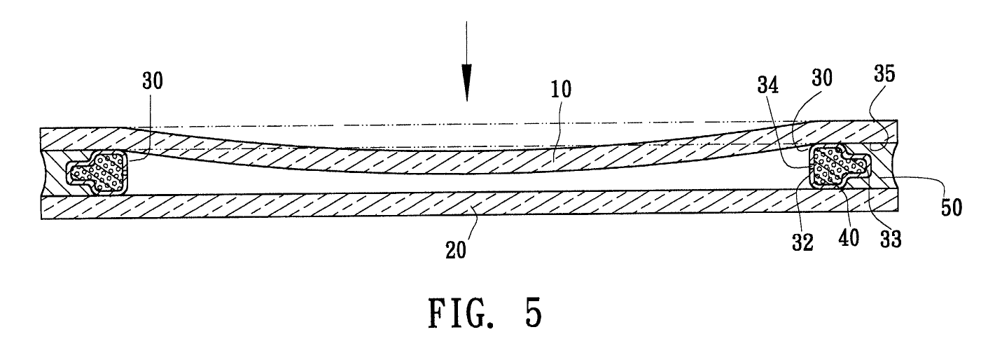

4. Referring to FIG. 5, the tempered glass board and the PC board are spaced from each other at a certain distance by the frame body. In case the tempered glass board suffers external impact, the distance will first buff the impact.

5. The frame body is sandwiched between the tempered glass board and the PC board. When sonic wave hits an article, the sonic wave will be reflected, absorbed and refracted to minimize noise. Accordingly, when the sonic wave passes through the tempered glass and a closed layer of air to reach the PC board which has quite good sound-isolating effect, the noise can be fully isolated. Therefore, the reinforced transparent glass assembly of the present invention has excellent sound-isolating effect.

6. The dimension and shape of the present invention can be elastically designed as necessary to achieve beautiful appearance and practical utility.

The above embodiments are only used to illustrate the present invention, not intended to limit the scope thereof. Many modifications of the above embodiments can be made without departing from the spirit of the present invention. For example, the PC board 20 and the glass board 10 can have an arched pattern in accordance with requirement for safety.

What is claimed is:

1. A reinforced transparent glass assembly comprising a glass board, a corresponding PC board and a frame body sandwiched between the glass board and the PC board, the frame body being hollow and having an interior space in which a drier is filled, the frame body having an inner rim and an outer rim opposite to the inner rim, multiple apertures being formed through the inner rim of the frame body to communicate with the interior space thereof, the frame body having a dimension smaller than those of the glass board and the PC board, whereby a recess is defined by the outer rim and the glass board and the PC board, a soft and resilient gum material being filled in the recess for binding the frame body, glass board and PC board together.

2. The reinforced transparent glass assembly as claimed in claim 1, wherein the outer rim of the frame body has an outward extending projection.

3. The reinforced transparent glass assembly as claimed in claim 1, wherein the adjoining faces of the glass board, PC board and frame body are all plane faces.

4. The reinforced transparent glass assembly as claimed in claim 1, wherein the glass board and PC board can be variously designed with a dimension and a shapes such as arched shape in accordance with specific requirement.
